(19) United States
(12) Patent Application Publication
(10) Pub. No.: US 2011/0105269 A1
(43) Pub. Date: May 5, 2011

(54) ROTATIONAL DRIVING FORCE TRANSMITTING APPARATUS

(76) Inventors: Ichiro Sato, Tokyo (JP); Kazunori Sato, Tokyo (JP); Hisaaki Suzuki, Tokyo (JP)

(21) Appl. No.: 12/599,819

(22) PCT Filed: May 15, 2008
(86) PCT No.: PCT/JP08/01218

§ 371 Date: Nov. 12, 2009

(30) Foreign Application Priority Data
May 15, 2007 (JP) 2007-129749
May 15, 2008 (JP) PCT/JP2008/001218

(51) Int. Cl. F16H 1/28

(52) U.S. Cl. 475/331

(57) ABSTRACT

To provide a rotational force transmission apparatus which can reduce loading on a motor or the like, decrease power or other energy consumption for input, and thereby improve output efficiency. A rotational force transmission apparatus includes an input unit and output unit; means of the output unit for receiving input from the input unit is a gear train made up of gears meshed linearly with each other, the gears including an inner output gear meshed with a stationary gear fixed to axially supporting means of an output shaft of the output unit, a free gear meshed with the inner output gear, and an outer output gear meshed with the free gear; the gear train receives the input from the input unit, revolves integrally along the stationary gear, and thereby rotationally drives the output shaft; and the numbers of teeth of the gears included in the gear train are set such that the free gear will not spin when the gear train revolves along the stationary gear.

### TECHNICAL FIELD

The present invention relates to a rotational force transmission apparatus, and more particularly to, a rotational force transmission apparatus interposed between a machine or appliance which requires a rotational driving force and a motor or other rotational driving source, or incorporated in the machine or appliance, to transmit the rotational driving force from the motor or other rotational driving source to the machine or appliance, where examples of the machine or appliance include vehicles, bicycles, generators, internal combustion engines, shredders, and various types of machine tool.

### BACKGROUND ART

Conventionally, the generators and other machines and appliances which require a rotational driving force do not allow for interposing a transmission apparatus which can transmit a rotational driving force with reduced power consumption for input even though a transmission apparatus is interposed to simply convert rotational speed. This is because it is considered that interposition of some kind of transmission apparatus between such a rotational driving source and a rotational machine or appliance increases mechanical loss, even resulting in increases in power consumption.

In contrast to such a general approach, the present inventors have been studying a transmission apparatus which can transmit a rotational driving force with reduced power consumption for input and have been proposing various types of rotational force transmission apparatus, but the proposed apparatus has not yet fully met the needs of the industry.
Patent Document 1: Japanese Patent Laid-Open No. 2001-21020
Patent Document 2: Japanese Patent Laid-Open No. 2003-247609
Patent Document 3: Japanese Patent Laid-Open No. 11-108126

### DISCLOSURE OF THE INVENTION

### Problems to be Solved by the Invention

As described above, conventional machines and appliances, such as generators which require a rotational driving force are driven directly by a motor or the like without interposition of a transmission apparatus which will increase mechanical loss, resulting in increases in power consumption, and little consideration is given to reduction of loading on the motor or the like or improvement of output efficiency. In view of the above circumstances, the present invention has an object to provide a rotational force transmission apparatus which reduces loading on the motor or the like, decreases power or other energy consumption for input, and thereby can improve output efficiency.

### Means for Solving the Problems

To achieve the above object, according to a first aspect of the present invention, there is provided a rotational force transmission apparatus, comprising an input unit and an output unit, characterized in that: means of the output unit for receiving input from the input unit is a gear train made up of gears meshed linearly with each other, the gears including an inner output gear meshed with a stationary gear fixed to axially supporting means of an output shaft of the output unit, a free gear meshed with the inner output gear, and an outer output gear meshed with the free gear; the gear train receives the input from the input unit, revolves integrally along the stationary gear, and thereby rotationally drives the output shaft; and the numbers of teeth of the gears included in the gear train are set such that the free gear will not spin when the gear train revolves along the stationary gear.

Preferably, the free gear is larger in diameter than the inner output gear and the outer output gear, and the inner output gear and the outer output gear are equal in diameter.

To achieve the above object, according to a fourth aspect of the present invention, there is provided a rotational force transmission apparatus, characterized in that: an input shaft and an output shaft are axially supported on a same axis, the input shaft including input means and an input gear, and the output shaft including output means and an output gear; a pair of first and second rotating arms are installed by being coupled by a coupling plate at one end; the first rotating arm is axially supported on the input shaft and the second rotating arm is axially supported on the output shaft; the second rotating arm axially supports an input internal gear internally meshed with the input gear; a first intermediate gear is installed at one end internally meshing with the input internal gear; at the other end, the first rotating arm axially supports a rotational gear shaft equipped with a second intermediate gear internally meshing with an intermediate internal gear axially supported by the first rotating arm; a coupling gear shaft of a third intermediate gear driven by the intermediate internal gear is axially supported by the first rotating arm and the second rotating arm; rotation of an outer output gear attached to an end of the coupling gear shaft is transmitted, via a free gear axially supported by the second rotating arm, to an inner output gear meshed with a stationary gear fixed to axially supporting means of the output shaft; the rotational gear shaft of the inner output gear is axially supported by a supporting arm axially supported by the output shaft; a fourth intermediate gear is mounted on the rotational gear shaft to internally mesh with an output internal gear fixed to the output shaft; input from the input means is transmitted to the output shaft to allow output therefrom; and the numbers of teeth of the inner output gear, the free gear, and the outer output gear which make up a gear train by meshing linearly are set such that the free gear will not spin when the gear train revolves along the stationary gear.

To achieve the above object, according to a fifth aspect of the present invention, there is provided a rotational force transmission apparatus, characterized in that: an input shaft and an output shaft are axially supported on a same axis, the input shaft including input means and an input pulley, and the output shaft including output means and an output gear; a pair of first and second rotating arms are installed by being coupled by a coupling plate at one end; the first rotating arm is axially supported on the input shaft and the second rotating arm is axially supported on the output shaft; a composite pulley which receives input from the input pulley is axially supported by a fixed gear shaft which bridges between the first rotating arm and the second rotating arm; a pulley rotationally driven by spinning of the composite pulley is axially supported by a coupling gear shaft which bridges between the first rotating arm and the second rotating arm; a free gear axially supported at an end of the fixed gear shaft is meshed with an outer output gear fixed to an end of the coupling gear shaft; rotation of the pulley, the coupling gear shaft, and the outer output gear which rotate together is transmitted, via the free gear, to a first inner output gear of a composite terminal gear meshed with a stationary gear fixed to axially supporting means of the output shaft; an end of a rotating gear shaft which axially supports the composite terminal gear is fixed to a supporting arm axially supported by the output shaft; a second inner output gear of the composite terminal gear internally meshes with an output internal gear fixed to the output shaft; input from the input means is transmitted to the output shaft to allow output therefrom; and the numbers of teeth of the first inner output gear, the free gear, and the outer output gear which make up a gear train are set such that the free gear will not spin when the gear train revolves along the stationary gear.

To achieve the above object, according to a sixth aspect of the present invention, there is provided a multi-stage rotational force transmission apparatus configured by linking together a plurality of the apparatuses according to any one of the first to fifth aspects, with the output shaft of the apparatus of the preceding stage serving as the input shaft of the apparatus of the succeeding stage.

### ADVANTAGES OF THE INVENTION

The rotational force transmission apparatus according to the present invention, when interposed in a transmission process of a rotational driving force, has the advantage of being able to practically increase the rotational driving force and reduce power consumption, thereby improving output efficiency and contributing to energy savings. Thus, the rotational force transmission apparatus according to the present invention can be used for vehicles, generators, machine tools, and other machines and appliances which require a rotational driving force.

### BEST MODE FOR CARRYING OUT THE INVENTION

An embodiment of the present invention will be described with reference to the accompanying drawings. First, an embodiment illustrated in FIGS. 1 to 3 will be described. In the figures, reference numeral 1 denotes a base on both ends of which shaft support walls 2 and 3 are erected. A bearing tube 4 in which a pair of bearings are fitted is installed on an upper end of the shaft support wall 2 to axially support an input shaft 5. Input means 6 such as a sprocket, gear, or pulley (pulley in the illustrated example), which receives input from a prime mover such as a motor is fixed on the input shaft 5 on the inner or outer side (outer side in the illustrated example) from the bearing tube 4. A first arm 7 is rotatably mounted on an inner end of the input shaft 5.

The first arm 7 has a bearing 8 at its center of gravity position to pass the input shaft 5. A balance weight 9 is installed at one end of the first arm 7. Two bearings 10 and 11 are installed at two locations—at the end and in a middle portion—of the first arm 7 on the side opposite from the balance weight 9. A shaft lock 13 is formed between the bearings 10 and 11 to lock a fixed gear shaft 12.

An input gear 15 is fixed to the tip of the input shaft 5 which extends further inward through the bearing 8. Thus, the input gear 15 rotates together with the input means 6 and input shaft 5 by being supported by the bearing tube 4. However, it is not that the rotation of the input shaft 5 rotationally drives the first arm 7 directly.

A bearing tube 17 similar to the bearing tube 4 of the shaft support wall 2 is installed on an upper end of the shaft support wall 3 to axially support an output shaft 18. The input shaft 5 and output shaft 18 are placed such that their axes will coincide. A second arm 19 corresponding to the first arm 7 is rotatably mounted on an inner end of the output shaft 18.

The second arm 19 has, at its center of gravity position, a bearing 20 axially supported on the inner end of the output shaft 18. A balance weight 21 corresponding to the balance weight 9 is installed at one end of the second arm 19. The balance weight 21 is coupled to the balance weight 9 of the first arm 7 via a coupling plate 14. Thus, the first arm 7 and second arm 19 rotate together in the same direction on the input shaft 5 and output shaft 18, respectively.

The second arm 19 has a bearing 22 at its end on the side opposite from the balance weight 21 and has two shaft locks 23 and 24 at locations closer to the bearing 20 at the center. The bearing 22 axially supports a coupling gear shaft 25 bridging between the bearings 11 and 22, in conjunction with the bearing 11 at the end of the first arm 7.

The input gear 15 at the inner end of the input shaft 5 internally meshes with an input internal gear 27. A supporting wheel 28 which supports the input gear 15 in conjunction with the input internal gear 27 is rotatably mounted on a fixed gear shaft 29 installed on the shaft lock 24 of the second arm 19. The input internal gear 27 is internally meshed with a first intermediate gear 30. A composite gear shaft 31 of the first intermediate gear 30 is axially supported by the bearing 10 of the first arm 7. A second intermediate gear 32 slightly larger in diameter than the first intermediate gear 30 is fixed to that end of the composite gear shaft 31 which is opposite from the first intermediate gear 30. The first intermediate gear 30 and second intermediate gear 32 rotate together. The reason why the second intermediate gear 32 is set to be larger in diameter than the first intermediate gear 30 is to increase rotational speed when a turning force is transmitted from the second intermediate gear 32 to an intermediate internal gear 33 internally meshed with the second intermediate gear 32.

A supporting wheel 34 which supports the intermediate internal gear 33 by being mounted integrally therewith is supported by the fixed gear shaft 12 installed on the shaft lock 13 of the first arm 7. The intermediate internal gear 33 is internally meshed with a third intermediate gear 35 which, being equal in diameter to the second intermediate gear 32, is fixed to the first arm 7 side end of the coupling gear shaft 25. An outer output gear 36 slightly larger in diameter than the third intermediate gear 35 is fixed to the other end of the coupling gear shaft 25. Consequently, the third intermediate gear 35 and outer output gear 36 rotate in the same direction via the coupling gear shaft 25 simultaneously.

The outer output gear 36 meshes with a free gear 38 axially supported by a fixed gear shaft 39 installed on the shaft lock 23 of the second arm 19. The free gear 38 meshes with an inner output gear 40 axially supported by a composite gear shaft 41. The inner output gear 40 meshes with a stationary gear 42 fixed to the bearing tube 17 on the shaft support wall 3. The composite gear shaft 41 is axially supported by a support arm 43 rotatably mounted on the output shaft 18 and a support frame 44 formed integrally with the second arm 19.

A fourth intermediate gear 45 is fixed to an inner end of the composite gear shaft 41 and internally meshes with an output internal gear 46. A supporting wheel 47 which supports the output internal gear 46 by being mounted integrally therewith is installed on the output shaft 18. Consequently, rotation of the output internal gear 46 is transmitted directly to the output shaft 18 and outputted therefrom.

According to the present invention, it is important that the numbers of teeth of the inner output gear 40, free gear 38, and outer output gear 36 which make up a gear train by meshing linearly are set such that the free gear 38 will not spin when the gear train revolves along the stationary gear 42. As an example, the numbers of teeth of the inner output gear 40 and outer output gear 36 may be set to 18 while the number of teeth of the free gear 38 may be set to 26. Incidentally, according to the present invention, when it is said that the free gear 38 does not spin, this means that the topside and bottom side of the free gear 38 are fixed relative to each other during the revolution (in the same sense as the movement of a Ferris wheel gondola). Regarding other gears, their spinning is to be understood in the general sense of the term.

A transmission path of the rotational driving force in the above configuration will be described. First, when the rotational driving force of the motor or the like is inputted in the input means 6, the input gear 15 rotates together with the input means 6 via the input shaft 5, rotationally driving the input internal gear 27 meshed with the input gear 15. Consequently, the input internal gear 27 spins on the fixed gear shaft 29, rotationally driving the first intermediate gear 30 internally meshing with the input internal gear 27. Since the first intermediate gear 30 is equal in diameter to the input gear 15, the two gears 30 and 15 coincide in rotational frequency.

Spinning operation of the first intermediate gear 30 is transmitted directly to the second intermediate gear 32 integrated via the composite gear shaft 31. Spinning operation of the second intermediate gear 32 acts to rotate the intermediate internal gear 33 internally meshed with the second intermediate gear 32. Consequently, the intermediate internal gear 33 spins on the fixed gear shaft 12. The spinning operation of the intermediate internal gear 33 rotationally drives the third intermediate gear 35 internally meshing therewith.

Spinning operation of the third intermediate gear 35 is transmitted directly to the outer output gear 36 via the coupling gear shaft 25, and then transmitted therefrom to the free gear 38 meshing with the outer output gear 36. The free gear 38 tries to rotationally drive the inner output gear 40 meshing therewith while the inner output gear 40 tries to rotationally drive the stationary gear 42 meshing therewith.

However, since the stationary gear 42 cannot rotate, being fixed to the bearing tube 17, the inner output gear 40 cannot spin on the spot. However, since the rotational driving force continues to be transmitted to the inner output gear 40 from the outer output gear 36 via the free gear 38, the action on the stationary gear 42 continues and the inner output gear 40 continues to be subjected to reaction from the stationary gear 42. Consequently, the inner output gear 40 rotates on a circumferential surface of the stationary gear 42 by meshing therewith. That is, while spinning, the inner output gear 40 revolves around the output shaft 18 along the stationary gear 42.

The outer output gear 36, free gear 38, and inner output gear 40 lie in the same straight line, and the numbers of teeth of the inner output gear 40, free gear 38, and outer output gear 36 which make up a gear train by meshing linearly are set such that the free gear 38 will not spin when the gear train revolves along the stationary gear 42. Thus, the gear train can be considered to be a single arm which rotates along a tooth flank of the stationary gear 42 (output shaft 18).

Spinning operation of the inner output gear 40 is transmitted directly to the fourth intermediate gear 45 via the composite gear shaft 41. While spinning, the fourth intermediate gear 45 revolves around the output shaft 18 together with the inner output gear 40. The fourth intermediate gear 45 orbits along an inner circumference of the output internal gear 46 whose gear shaft is provided by the output shaft 18 with which the fourth intermediate gear 45 internally meshes. Consequently, when the fourth intermediate gear 45 spins and revolves, the output internal gear 46 is driven rotationally. The rotation of the output internal gear 46 is outputted from the output shaft 18 mounted integrally with the output internal gear 46.

The revolving operation of the inner output gear 40 is transmitted from the support frame 44 axially supporting the composite gear shaft 41 to the first arm 7 coupled to the second arm 19, via the support arm 43 mounted integrally on the support frame 44 and via the second arm 19 and coupling plate 14. Consequently, since the first arm 7 and second arm 19 rotate on the input shaft 5 and output shaft 18, respectively, rotating elements other than the first arm 7, second arm 19, input gear 15, output internal gear 46, and support arm 43 axially supported directly by, or fixed to, the input shaft 5 or output shaft 18 revolve around the input shaft 5 or output shaft 18 while performing a spinning operation.

In the transmission process of the rotational driving force, as the inner output gear 40 spins and revolves, the gear train made up of the outer output gear 36, free gear 38, and inner output gear 40 revolves around the stationary gear 42, acting as if the gear train were a single arm. In so doing, because of the revolution together with the outer output gear 36 and inner output gear 40 and the gear ratio to the output gears 36 and 40, the free gear 38 revolves without spinning (in the same manner as a Ferris wheel, as described above) between the spinning output gears 36 and 40.

This behavior of the free gear 38 makes it possible to transmit twice the rotational driving force. This is because the principle of leverage comes into play among the outer output gear 36, free gear 38, inner output gear 40, and stationary gear 42. Specifically, since the point of contact between the outer output gear 36 and free gear 38, point of contact between the free gear 38 and inner output gear 40, and point of contact between the inner output gear 40 and stationary gear 42 are considered to act as a power point, point of application, and fulcrum, respectively, a larger force is applied to the point of application than to the power point. The principle of leverage does not operate if the free gear 38 spins even slightly. To improve the output efficiency based on the principle of leverage, the free gear 38 is configured to be larger in diameter than the outer output gear 36 and inner output gear 40.

FIG. 4 shows a second embodiment in which part (the input unit) of the gear set according to the first embodiment is replaced by a belt drive system. In FIG. 4, components denoted by the same reference numerals as in FIGS. 1 to 3 correspond to components according to the first embodiment, and thus detailed description thereof will be omitted.

According to the second embodiment, an input pulley 50 is installed on the inner end of the input shaft 5, and a belt 51 looped over the input pulley 50 is looped over a small-diameter pulley 53 of a composite pulley 52 which is an integrated combination of large and small pulleys. The fixed gear shaft 39 according to the second embodiment is extended to the first arm 7 by passing through the second arm 19 and is fixed thereto. The composite pulley 52 is axially supported by being mounted between the first arm 7 and second arm 19 of the fixed gear shaft 39.

A belt 55 looped over a large-diameter pulley 54 of the composite pulley 52 is looped over a pulley 56 installed on the coupling gear shaft 25. Consequently, the rotational driving force inputted via the input shaft 5 is transmitted from the input pulley 50 to the small-diameter pulley 53 via the belt 51, and then from the large-diameter pulley 54 to the pulley 56 via the belt 55, rotationally driving the coupling gear shaft 25 to which the pulley 56 is fixed.

Subsequently, rotational operation is transmitted from the outer output gear 36 to the output internal gear 46 via the free gear 38, inner output gear (first inner output gear) 40, and fourth intermediate gear (second inner output gear) 45, and then outputted from the output internal gear 46, as in the case of the first embodiment.

To verify effectiveness of the apparatus according to the present invention, an experiment shown in FIG. 5 was conducted. Specifically, a DC motor 61 was driven using a 48-V battery 60 as a power supply, a generator 62 was driven by output from the DC motor 61, and the battery 60 was charged using output from the generator 62. In so doing, the apparatus 64 according to the present invention was interposed between the DC motor 61 and generator 62 to verify its effectiveness.

However, the DC motor 61 was set to produce an insufficient output to drive the generator 62. That is, in the above system, when a switch 65 is turned on without interposition of the apparatus 64 according to the present invention, the DC motor 61 will become overheated.

In the above experiment, the motor switch 65 was turned on to drive the DC motor 61 using the battery 60 as a power supply, and the generator 62 was started via the apparatus 64 according to the present invention. The operation was continued for some time, and it was confirmed that the DC motor 61 operated stably without overheat, allowing the battery 60 to be charged constantly with the output from the generator 62. In so doing, the output from the generator 62 was maintained at 50 V, 22 A and values of input in the DC motor 61 were 48 V, 12 A.

Next, observations were made by turning off the motor switch 65 and thereby stopping the input from the battery 60 into the DC motor 61. The present apparatus 64 continued to rotate consistently without showing any sign of stopping. On the output side of the generator 62, the voltage value was 50 V and amperage was 45 A, and the battery 60 continued to be charged.

In this way, when the apparatus 64 according to the present invention was operated using as input the rotational driving force provided by the output of the DC motor 61 which normally produced an insufficient output to drive the generator 62 and the output of the apparatus 64 was used as a driving source of the generator 62, the DC motor 61 and generator 62 were successfully operated in a stable manner. Thus, it is apparent that the apparatus 64 according to the present invention reliably amplified the rotational driving force provided by the output of the DC motor 61, and consequently the effectiveness of the present invention was sufficiently verified.

The most preferred embodiments of the present invention have been described in some detail, but it is obvious that a wide range of other embodiments can be configured without departing from the spirit and scope of the present invention. Accordingly, it is to be understood that the present invention is not to be limited by the specific embodiments, but only by the scope of the appended claims.

### BRIEF DESCRIPTION OF THE DRAWINGS

FIG. 1 is a longitudinal sectional view showing a configuration example of a rotational force transmission apparatus according to the present invention;

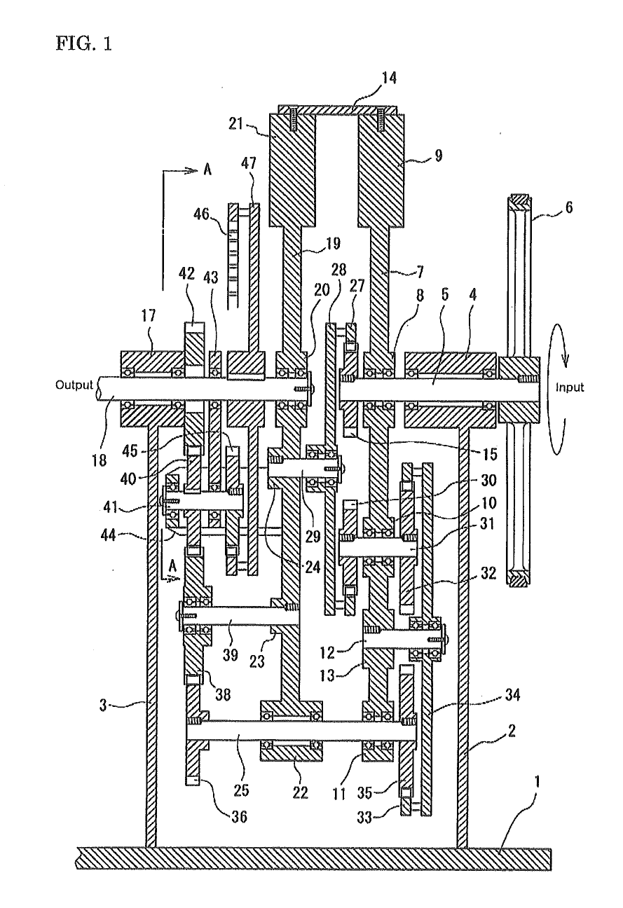

FIG. 2 is an exploded perspective view showing a configuration example of the rotational force transmission apparatus according to the present invention;

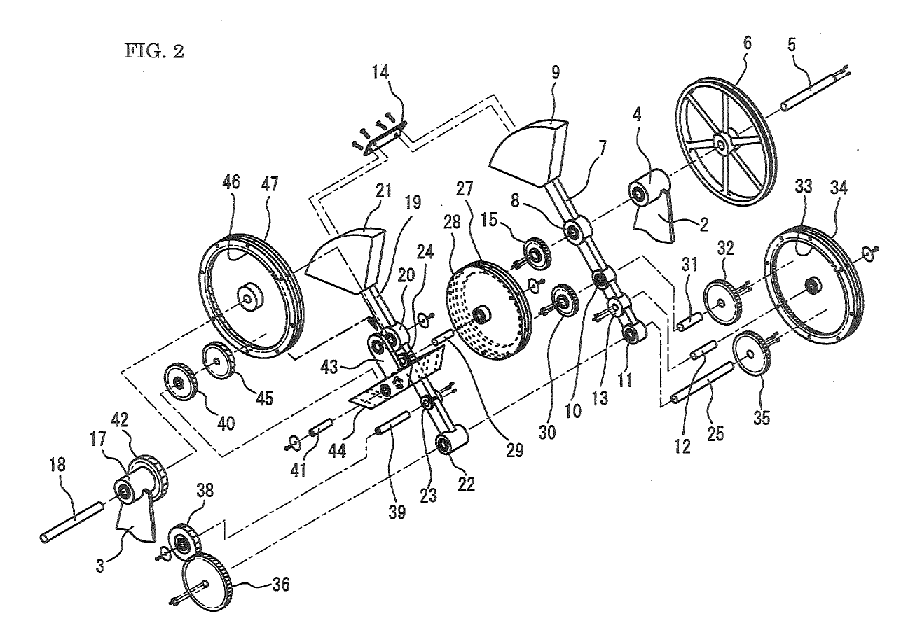

FIG. 3 is a sectional view taken along line A-A in FIG. 2;

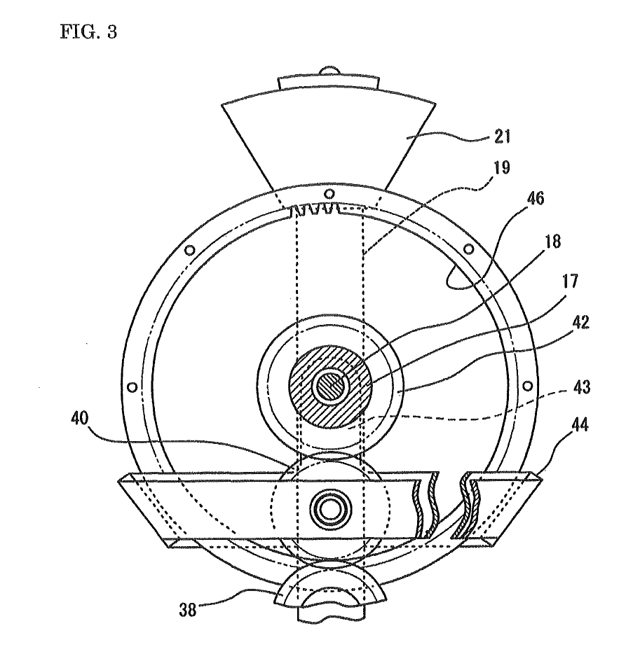

FIG. 4 is a longitudinal sectional view showing another configuration example of the rotational force transmission apparatus according to the present invention; and

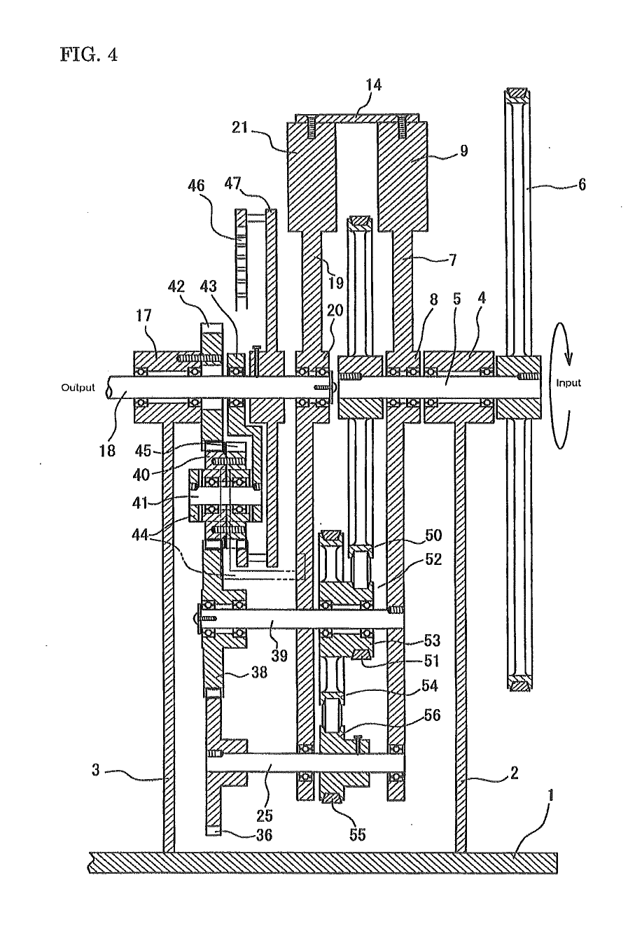

FIG. 5 is a diagram showing a method for an experiment conducted to verify effectiveness of the present invention.

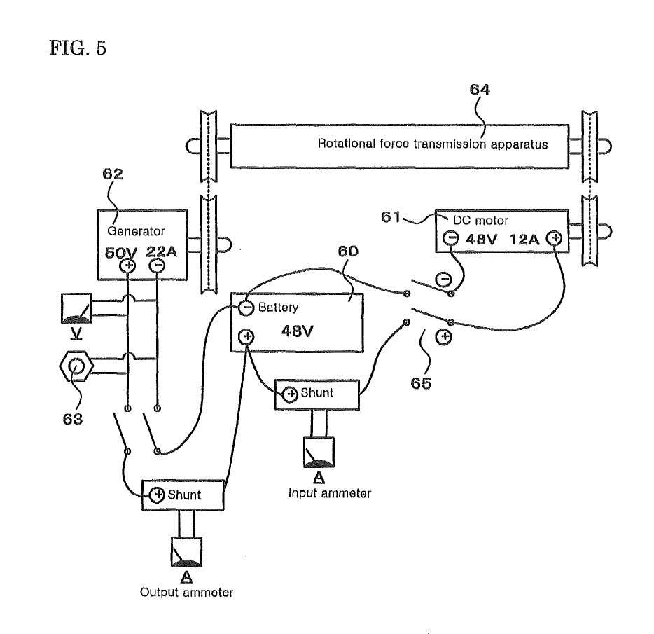

1. A rotational force transmission apparatus, comprising an input unit and an output unit, wherein means of the output unit for receiving input from the input unit is a gear train made up of gears meshed linearly with each other, the gears including an inner output gear meshed with a stationary gear fixed to axially supporting means of an output shaft of the output unit, a free gear meshed with the inner output gear, and an outer output gear meshed with the free gear; the gear train receives the input from the input unit, revolves integrally along the stationary gear, and thereby rotationally drives the output shaft; and the numbers of teeth of the gears included in the gear train are set such that the free gear will not spin when the gear train revolves along the stationary gear.

2. The rotational force transmission apparatus according to claim 1, wherein the free gear is larger in diameter than the inner output gear and the outer output gear.

3. The rotational force transmission apparatus according to claim 2, wherein the inner output gear and the outer output gear are equal in diameter.

4. A rotational force transmission apparatus, wherein an input shaft and an output shaft are axially supported on a same axis, the input shaft including input means and an input gear, and the output shaft including output means and an output gear; a pair of first and second rotating arms are installed by being coupled by a coupling plate at one end; the first rotating arm is axially supported on the input shaft and the second rotating arm is axially supported on the output shaft; the second rotating arm axially supports an input internal gear internally meshed with the input gear; a first intermediate gear is installed at one end internally meshing with the input internal gear; at the other end, the first rotating arm axially supports a rotational gear shaft equipped with a second intermediate gear internally meshing with an intermediate internal gear axially supported by the first rotating arm; a coupling gear shaft of a third intermediate gear driven by the intermediate internal gear is axially supported by the first rotating arm and the second rotating arm; rotation of an outer output gear attached to an end of the coupling gear shaft is transmitted, via a free gear axially supported by the second rotating arm, to an inner output gear meshed with a stationary gear fixed to axially supporting means of the output shaft; the rotational gear shaft of the inner output gear is axially supported by a supporting arm axially supported by the output shaft; a fourth intermediate gear is mounted on the rotational gear shaft to internally mesh with an output internal gear fixed to the output shaft; input from the input means is transmitted to the output shaft to allow output therefrom; and the numbers of teeth of the inner output gear, the free gear, and the outer output gear which make up a gear train by meshing linearly are set such that the free gear will not spin when the gear train revolves along the stationary gear.

5. A rotational force transmission apparatus comprising: an input shaft and an output shaft are axially supported on a same axis, the input shaft including input means and an input pulley, and the output shaft including output means and an output gear; a pair of first and second rotating arms are installed by being coupled by a coupling plate at one end; the first rotating arm is axially supported on the input shaft and the second rotating arm is axially supported on the output shaft; a composite pulley which receives input from the input pulley is axially supported by a fixed gear shaft which bridges between the first rotating arm and the second rotating arm; a pulley rotationally driven by spinning of the composite pulley is axially supported by a coupling gear shaft which bridges between the first rotating arm and the second rotating arm; a free gear axially supported at an end of the fixed gear shaft is meshed with an outer output gear fixed to an end of the coupling gear shaft; rotation of the pulley, the coupling gear shaft, and the outer output gear which rotate together is transmitted, via the free gear, to a first inner output gear of a composite terminal gear meshed with a stationary gear fixed to axially supporting means of the output shaft; an end of a rotating gear shaft which axially supports the composite terminal gear is fixed to a supporting arm axially supported by the output shaft; a second inner output gear of the composite terminal gear internally meshes with an output internal gear fixed to the output shaft; input from the input means is transmitted to the output shaft to allow output therefrom; and the numbers of teeth of the first inner output gear, the free gear, and the outer output gear which make up a gear train are set such that the free gear will not spin when the gear train revolves along the stationary gear.

6. A multi-stage rotational force transmission apparatus configured by linking together a plurality of the apparatuses according to claim 1, with the output shaft of the apparatus of the preceding stage serving as the input shaft of the apparatus of the succeeding stage.
